(19) United States
(12) Patent Application Publication
(10) Pub. No.: US 2005/0128346 A1
(43) Pub. Date: Jun. 16, 2005

(54) Digital camera

(75) Inventors: Wei Cheng Huang, Taipei County (TW); Peng Yuan Lee, Taipei County (TW)

Correspondence Address: BACON & THOMAS, PLLC, 625 SLATERS LANE, FOURTH FLOOR, ALEXANDRIA, VA, 22314, US

(73) Assignee: CHICONY ELECTRONICS CO. LTD, Taipei County (TW)

(21) Appl. No.: 10/732,369

(22) Filed: Dec. 11, 2003

(51) Int. Cl. H04N 5/225

(52) U.S. Cl. 348/375

(57) ABSTRACT

A digital camera is provided, comprising a case, a lens, a liquid crystal display, a control button and a light emitting object, wherein the case has a rear cover, the control button is located on the rear cover, and the light emitting object is located on the back of the control button. Through the variations of the lighting color of the light emitting object irradiated on the control button, the user can recognize the current usage mode of the digital camera by the color through the light emitting object, thus making operations thereof more recognizable.

### BACKGROUND OF THE INVENTION

1. Field of the Invention

The present invention relates to a digital camera, and particularly to a digital camera having a control button by changing the light color of the light emitting object to show the current mode, thus making operations thereof more recognizable.

2. Description of the Related Art

The digital camera currently is often used to establish the web pages, make memorable pictures, establish the picture database, and has a great potential on market development. The main components include the image sensing device (CCD Sensors or CMOS), ASIC for high speed digital signal processing, memory card, display, and lens, etc. The major advantages of the digital camera are that, the digital camera does not need the films and the development, and the mobility and the economy issues are better than the conventional cameras. From the view of the emerging consumer electronic products, the product is a fully electronic camera for immediately developing and printing, and from the view of the computer peripheral products, it can be treated as a computer three-dimensional image input equipment (scanner), and has the possibility to replace part of the middle-to-low level of image scanners. Further, as the communication products, most digital cameras have the function of picking up video signals, so that they can be the cameras with reasonable prices by adding the video pick-up card through other image transmitting device.

The control button of the conventional digital camera is provided for the necessary configuration during operating the digital camera by the user, or is used to browse the pictures picked up using the control button. Nevertheless, the conventional digital cameras can only provide the required function menu selected by pressing, and cannot provide the current usage mode for the user. Thus, the user may falsely press the control button under different usage modes, which is a disadvantage needed to be improved.

### SUMMARY OF THE INVENTION

The object of the present invention is to provide a digital camera, which can change the lighting color of a light emitting object irradiated on a control button so as to show the current mode of the digital camera, thus making operations thereof more recognizable.

The digital camera for the above-mentioned object includes a case, a lens, a liquid crystal display, a control button and a light emitting object, which is characterized in that, the control button is located in front of the light emitting object, and by changing the lighting color of the light emitting object irradiated on the control button, the current usage mode can be shown.

The control button comprises a forward, a backward, a left, a right and a middle buttons.

The forward, backward, left and right buttons are of transparent type.

The light emitting object is a light emitting object having arbitrary colors.

The light emitting object is a light emitting diode (LED), or is made of other light emitting material.

The light emitting object is composed of a first set of LEDs and a second set of LEDs.

The first set of LEDs and the second set of LEDs are biasly arranged so as to form a rectangular body.

The first set of LEDs is located between the forward and left buttons, and between the right and backward buttons, and illuminates biasly.

The first set of LEDs is made of green light emitting objects, and the green light emitting objects are used to represent the standby mode.

The second set of LEDs is located between the forward and right buttons, and between the left and backward buttons, and illuminates biasly.

The second set of LEDs is made of red light emitting objects, and the green light emitting objects are used to represent the operation mode.

### BRIEF DESCRIPTION OF THE DRAWINGS

These and other features, aspects and advantages of the present invention will become better understood with regard to the following description, appended claims and accompanying drawings that are provided only for further elaboration without limiting or restricting the present invention, where:

FIG. 1 is an exploded three-dimensional diagram of the digital camera according to the present invention.

FIG. 2 is a three-dimensional assembly diagram of the digital camera according to the present invention.

### DETAILED DESCRIPTION OF THE PREFERRED EMBODIMENT

The following is a detailed description of the best presently known modes of carrying out the inventions. This description is not to be taken in a limiting sense, but is made merely for the purpose of illustrating the general principles of the inventions.

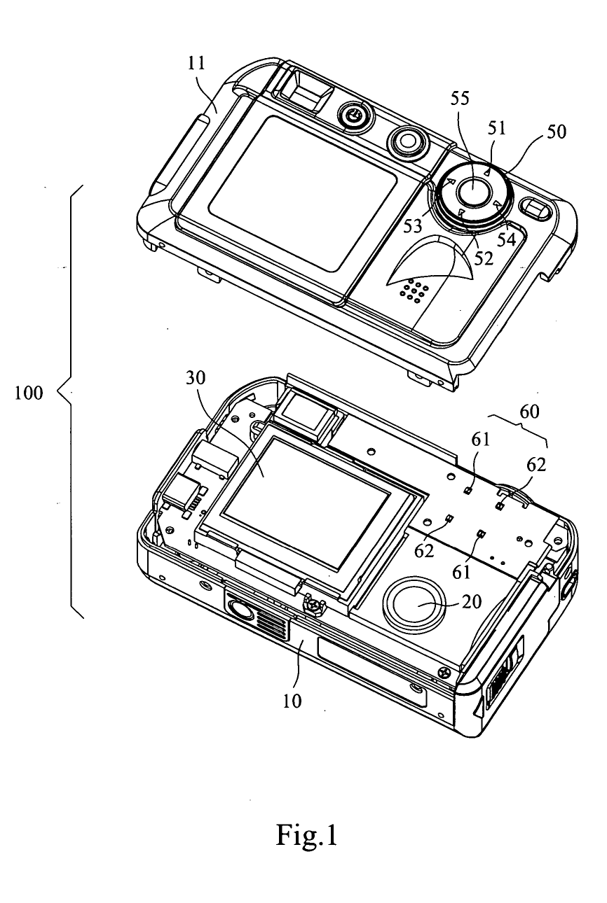

Referred to FIG. 1, the figure shows an exploded three-dimensional diagram of the digital camera according to the present invention. The digital camera 100 according to the present invention includes: a case 10 having a rear cover 11; a lens 20 located on one side of the case 10; a liquid crystal display 30 configured on the other side of the case 10; a control button 50 located above the rear cover 11; and, a light emitting object 60 located on the rear side of the control button 50.

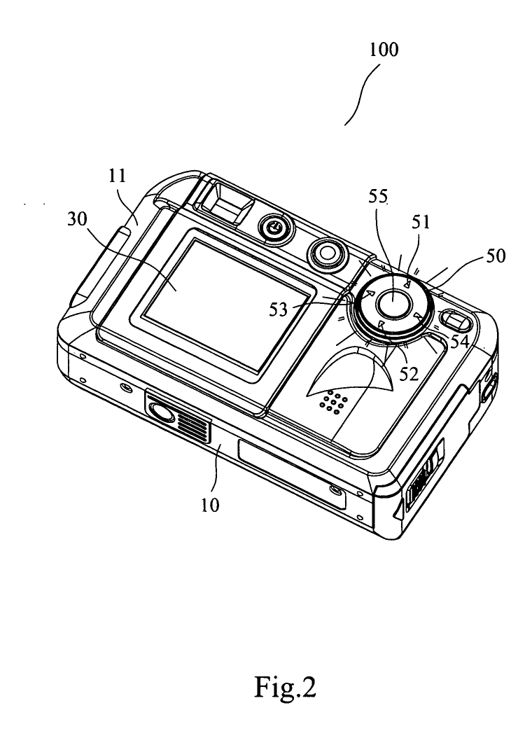

Next, referred to FIG. 1 in accordance with FIG. 2, the figure shows a three-dimensional assembly diagram of the digital camera according to the present invention, wherein the control button 50 comprises a forward, a backward, a left, a right and a middle buttons 51, 52, 53, 54, 55, and the forward, backward, left and right buttons 51, 52, 53, 54 are of transparent types. The light emitting object 60 comprises two sets of light emitting diodes (LEDs) 61, 62. The light emitting object 60 is arranged as a rectangular body in accordance with the forward, backward, left and right buttons 51, 52, 53, 54 of the control button 50. The first set of LEDs 61 and the second set of LEDs 62 are alternately arranged biasly, such that the first set of LEDs 61 is located between the forward and left buttons 51, 53, and between the right and backward buttons 54, 52, whereas the second set of LEDs 62 is located between the forward and right buttons 51, 54, and between the left and backward buttons 53, 52. In an embodiment according to the present invention, the first set of LEDs 61 is made of green light emitting objects representing that the camera is currently under the standby mode, while the second set of LEDs 62 is made of red light emitting objects representing that the camera is currently under the operation mode.

Then, referred to FIG. 2, in which, when starting the digital camera 100, the first set of LEDs 61 located between the forward and left buttons 51, 53, and between the right and backward buttons 54, 52 are lighted biasly, such that the control button 50 shows the green light through the transparent forward, backward, left, and right buttons 51, 52, 53, 54. The middle button 55 can also show the green light from gaps in the periphery to make the whole control button 50 exhibiting the green light, such that the user recognizes that the camera is currently under the standby mode. When the user desires to select the configuration functions in a function menu, any button of the control button 50 can be pressed so as to select the required function, then the first set of LEDs 61 will go off by being pressed, and the second set of LEDs 62 between the forward and right buttons 51, 54, and between the left and backward buttons 53, 52 are driven to light biasly. The control button 50 can also show the red light through the transparent bodies of the forward, backward, left and right buttons 51, 52, 53, 54, and the middle button 55 shows the red light from the gaps in the periphery to make the whole control button 50 exhibiting the red light, such that the user can recognize that the camera is currently under the standby mode, so the user may proceed to switch to the usage mode. At this time, for the operation of the digital camera 100, the user can recognize that the camera is currently in operation. With this kind of mechanism, the user can clearly recognize the current usage mode.

After the detailed description of the preferred embodiment according to the present invention, the skilled people in the art can clearly understand that there are various alternatives and changes without departing from the spirit and scope of the following claims, and the present invention is not limited to the implementation of the embodiments in the application document. For example, the light emitting object of the present invention can be provided in any color, and the light emitting objects can be the light emitting diodes (LEDs), or can be made of other light emitting material.

1. A digital camera comprising
a case;
a lens;
a liquid crystal display;
a control button; and
a light emitting object;
characterized in that said control button being located in front of said light emitting object, the current usage mode being shown through the variations of the lighting color of said light emitting object irradiated on said control button.

2. The digital camera of claim 1, wherein said control button comprises a forward, a backward, a left, a right and a middle buttons.

3. The digital camera of claim 2, wherein said forward, backward, left and right buttons are of transparent type.

4. The digital camera of claim 1, wherein said light emitting object is a light emitting object having arbitrary colors.

5. The digital camera of claim 1, wherein said light emitting object is a light emitting diode (LED), or is made of other light emitting material.

6. The digital camera of claim 1., wherein said light emitting object comprises a first set of LEDs and a second set of LEDs.

7. The digital camera of claim 6, wherein said first set of LEDs and said second set of LEDs are biasly arranged to form a rectangular body.

8. The digital camera of claim 7, wherein said first set of LEDs biasly illuminates.

9. The digital camera of claim 8, wherein said first set of LEDs is made of green light emitting objects for represent the standby mode.

10. The digital camera of claim 7, wherein said second set of LEDs biasly illuminates.

11. The digital camera of claim 10, wherein the second set of LEDs is made of red light emitting objects representing the operation mode.
